(19) United States
(12) Patent Application Publication
(10) Pub. No.: US 2004/0039570 A1
(43) Pub. Date: Feb. 26, 2004

(54) Method and system for multilingual voice recognition

(76) Inventors: Steffen Harengel, Muenchen (DE); Meinrad Niemoeller, Holzkirchen (DE)

Correspondence Address: BELL, BOYD & LLOYD, LLC, P. O. BOX 1135, CHICAGO, IL, 60690-1135, US

(21) Appl. No.: 10/432,971

(22) PCT Filed: Nov. 22, 2001
(86) PCT No.: PCT/EP01/13608

(30) Foreign Application Priority Data
Nov. 28, 2000 (EP) 001260003.3

(51) Int. Cl. G10L 15/00

(52) U.S. Cl. 704/232

(57) ABSTRACT

The present invention provides for a method and system of voice recognition, in particular for navigation in a hypertext navigation system. For each new word, a language identification stage, in particular embodied as a neural network, is used to determine the inclusion of the word in a language or a dialect with a given probability factor and the grapheme/phoneme relationship corresponding to the word with the greatest probability coefficient in the phonetic lexicon, or in at least one of the several phonetic lexica, is updated.

### BACKGROUND OF THE INVENTION

The present invention relates to both a method and a system for voice recognition, in particular for navigating in a hypertext navigation system, on the basis of voice inputs in a multiplicity of predetermined languages or dialects.

Hypertext systems are acquiring increasing importance in many areas of data and communication technology. An essential feature of all hypertext systems is the possibility of navigation. Special character sequences in a hypertext document, usually referred to as links or hyper-links, are used for hypertext navigation.

Nowadays, in order to increase operator convenience, conventional acoustic voice recognition systems (i.e., systems for recognizing spoken language), are integrated with hypertext systems, which are also referred to as browsers. Such a voice recognition system has to be capable of recognizing any word which could occur as a link in a hypertext document. For this purpose, when an HTML (Hypertext Markup Language) language is loaded, the texts of the links are added dynamically to the voice recognizer as new words. When the HTML page is exited, the words are extracted from the vocabulary again so that the optimum vocabulary which is suitable for the HTML page is always located in the voice recognizer.

DE 44 40 598 C1 by the applicant describes a corresponding hypertext navigation system as well as a hypertext document which can be handled in such a navigation system, as well as a method for generating such a document. Means for adapting a voice recognition device to contents of called hypertext documents which evaluate supplementary data which is linked to a called hypertext document and supports the recognition of hyperlinks which are addressed by the user are proposed in such publication. Furthermore, it is proposed that the voice recognition device should be set up in each case after the reception of a called hypertext document using generally valid pronunciation rules for recognizing the hyperlinks. Furthermore, there is a provision (inter alia) for a specific hypertext document to contain, as supplementary data, a lexicon and a probability model; the lexicon containing hyperlinks and phoneme sequences assigned thereto as entries and the probability model permitting a spoken word or a sequence of spoken words to be assigned to an entry in the lexicon.

Therefore, as is known, pronunciation lexicons are used as the knowledge base for voice recognition. In such pronunciation lexicons, a phonetic transcription in a specific format (for example, Sampa format) is specified for each word of the vocabulary. These are what are referred to as “canonistic forms” which correspond to a pronunciation standard. In this context, it is possible to store and use a number of phonetic transcriptions for one word.

A substantial problem of such voice recognition systems is that very large lexicons are necessary for comprehensive vocabularies for discriminating users, something which reduces the processing speed and the recognition power of these systems to an unacceptable degree. Even if it were possible to use very large pronunciation lexicons, it still would not be possible in this way to recognize the numerous neologisms and proper names which are so typical of hypertext networks such as the World Wide Web (www).

A fundamental problem when navigating in a hypertext navigation system is that the language of an HTML page or of a link is not known a priori. Since the representation of the orthography of a word in a phonetic system is dependent on the language, the results of such a conversion in real voice recognition systems are often faulty, wherein the recognition power is also correspondingly low. The acoustic models, such as hidden Markov models which are used in voice recognition, are also language-dependent as the sound modeling which is stored there is generated by a training process with voice data of a specific language or a specific dialect.

A further problem when navigating in a hypertext navigation system on the basis of voice inputs lies in the fact that within an HTML page it is often possible for there to be mixing of languages and, thus, different pronunciations so that it is often impossible to clearly define the language of an entire website.

The present invention is, therefore, directed toward a method of the generic type, in particular for navigating in a hypertext navigation system, which ensures a high processing speed and recognition power.

### SUMMARY OF THE INVENTION

Accordingly, the present invention includes the fundamental idea of using a language identification stage for each new word of a text to determine the assignment, subject to a probability coefficient, to at least one language or one dialect. It also includes the concept of entering, for each new word, the respective grapheme-phoneme assignment for a language or dialect in a pronunciation lexicon of at least one of a number of pronunciation lexicons. If the probability coefficient for the assignment of a word to at least one language or one dialect exceeds the threshold value, the grapheme-phoneme assignment which corresponds to the respective word is supplemented in the pronunciation lexicon.

In particular, for a hypertext document, the relevant (or most probable) language is determined for each word at the word level and the individual results are subsequently averaged to form an overall result. Here, the assignment of a word to a language or a dialect is determined with a high degree of probability by using a neural network.

Preferably, for each new word, the probability coefficients for the assignment of the word to a specific language or dialect are fed to a language assignment stage. The probability coefficients are evaluated in this language assignment stage, the evaluation being carried out via their relationship to one another or to the predetermined threshold value. The language-specific or dialect-specific grapheme-phoneme assignment is generated for each evaluated word in at least one of a number of phoneme recognition stages.

Determination of the assignment to a language or a dialect is preferably carried out in the language identification stage via the orthography of the word. In this way, unknown words can be detected as a language identification stage which is embodied as a neural network learns the characteristics of the orthography of a language.

It is advantageous that, in each case, pronunciations of the word in the specific language or dialect are generated dynamically in the phoneme recognition stages. These dynamically generated pronunciations are then introduced for the running time into the pronunciation lexicon or the language-specific or dialect-specific pronunciation lexicon of a voice recognizer so that the latter can generate corresponding HMM state sequences from them and enter them into its search space.

In one embodiment, the language identification stage is formed by a single neural network. The neural network has an output node for each predetermined language or dialect. This output node then specifies the probability coefficients which indicate that a grapheme window corresponding to the new word belongs to the corresponding language or dialect. However, the language identification stage also can be formed by a multiplicity of neural networks which each have a single output node. The output node specifies the probability coefficient which indicates that a grapheme window which corresponds to a new word belongs to the corresponding language or dialect.

According to a further embodiment of the present invention, a coherent language-specific or dialect-specific neural network is used in which the language or dialect which a new word is assigned to is determined and a language-specific or dialect-specific grapheme-phoneme assignment is generated. This neural network contains nodes for the language identification (German, English, etc.) and the phoneme assignment in the output layer.

Preferably, by multiplying the probability coefficients of the word for the respective language or the respective dialect, an assignment is determined in the language identification stage from probability coefficients which are determined on a grapheme basis.

In the phoneme recognition stages, an assignment probability for all the assignable phonemes is preferably determined for each grapheme via a neural network calculation process.

Here, the valid phoneme sequence for the new word will be obtained from the sequence of the phonemes with the highest assignment probabilities for all graphemes.

A training process is necessary for each neural network, a pronunciation lexicon being used as training material for each language or each dialect. The pronunciation lexicon contains the respective grapheme sequences (words) and the associated phoneme sequences (languages). The neural network is trained, in particular, via an iterative method in which what is referred to as “error back propagation” is used as the learning rule. In this method, the mean quadratic error is minimized. It is possible to use this learning rule to calculate deduction probabilities and, during the training, these deduction probabilities are calculated for all output nodes for the predefined grapheme windows of the input layer.

The network is trained in the training patterns in a number of iterations, the training sequence being preferably determined randomly for each iteration. After each iteration, the assignment accuracy which is achieved is checked using a validation record which is independent of the training material. The training process is continued for as long as an increase in the assignment accuracy is achieved after each subsequent iteration. The training is therefore terminated at a point at which the assignment accuracy for the validation record no longer increases.

After termination of the training, that is to say after the neural network has been learned, the pronunciation lexicon is updated, with the phoneme sequences which are entered in it being assigned to the respective language. The most important application of the proposed solution, from a current point of view, is when navigating in HTML pages in a data network which is organized according to an IP protocol; in particular, the Internet. The text documents here are the hypertext documents, with new words being particularly formed via hyperlinks and/or system instructions. However, this solution also can be applied for other applications of voice control using terms originating from text documents.

For a coherent text document, in particular a hypertext document, a statement of assignment, subject to a probability coefficient, to a language or a document is determined by evaluating the probability coefficients acquired at the grapheme level or the probability coefficients acquired at the word level, with a language-specific or dialect-specific or multilanguage HMM then being activated as a function of the evaluation result.

In order to carry out the method, a voice recognition system is specified which, for processing voice inputs in a multiplicity of predetermined languages or dialects, has a dynamically updated pronunciation lexicon and contains a language identification stage which is assigned to at least one language or one dialect in order to determine the assignment of each new word, which assignment is subject to a probability coefficient.

A language assignment stage which, in order to evaluate the probability coefficients of each word in their relationship to one another and/or to a predetermined threshold value, is preferably connected downstream of the language identification stage. In order to generate at least one grapheme-phoneme assignment which is valid for the respective word in a language or a dialect, a multiplicity of phoneme recognition stages which are connected downstream of the language assignment stages are used. The language identification stages and the phoneme recognition stages are embodied as a neural network in an appropriate embodiment. The neural network is preferably a layer-oriented, forward-directed network with full intermeshing between the individual layers.

The voice recognition system contains suitable parts for statistically evaluating the probability coefficients on the grapheme level or word level. As a result, the assignment of the entire text document, in particular hypertext document, to an overall probability coefficient characterizing a predetermined language or dialect is derived.

Additional features and advantages of the present invention are described in, and will be apparent from, the following Detailed Description of the Invention and the Figures.

### BRIEF DESCRIPTION OF THE FIGURE

FIG. 1 shows a functional schematic block diagram for assistance in describing the implementation of the present invention.

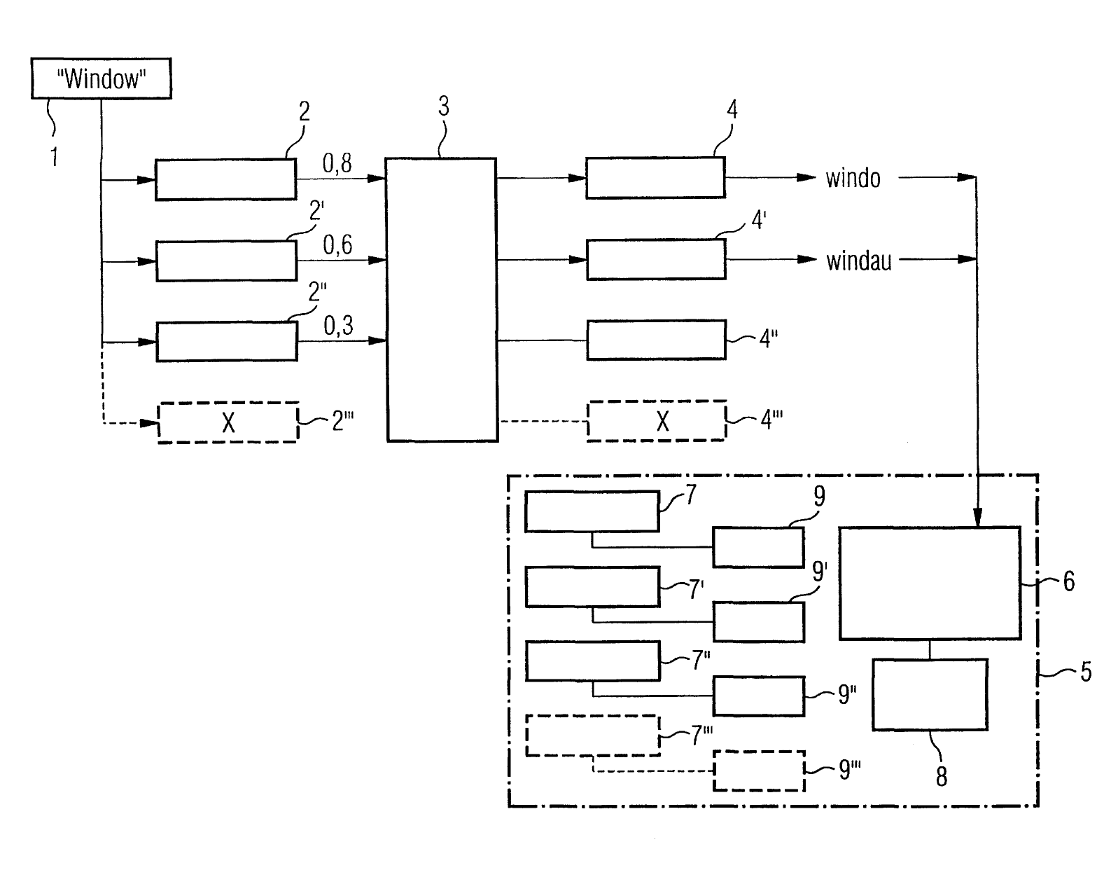

### DETAILED DESCRIPTION OF THE INVENTION

The voice recognition system has an input device 1 for inputting a new word, a language identification stage 2, 2′, 2″, 2′″ for the German, English and French languages and a further language X for determining the assignment, subject to a probability coefficient, of each new word to one of these languages, a language assignment stage 3, connected downstream of the language identification stages 2, 2′, 2″, 2′″, for evaluating the probability coefficients of each word for each of these languages in their relationship to one another and to a predetermined threshold value, as well as phoneme recognition stages 4, 4′, 4″, 4′″, connected downstream of the language assignment stage 3, for the German, English and French languages and a further language X for generating at least one grapheme-phoneme assignment which is valid for the corresponding word of a language. Furthermore, the system includes an HMM voice recognizer 5 which contains a mixed pronunciation lexicon 6 as well as further language-specific pronunciation lexicons 7, 7′, 7″, 7′″ for the German, English and French languages and a further language X and in which a mixed HMM 8 and language-specific HMM 9, 9′, 9″ and 9′″ are correspondingly implemented.

In this exemplary embodiment, for a complete hypertext document, a language is determined at the word level via the language assignment stage 3 for all the character sequences to be recognized; specifically, possible links. The words are analyzed and these individual results are then added in an overall result to the HMM voice recognizer 5, with either a language-specific HMM or a multilingual HMM being activated.

If a word, such as the English word “window”, which is unknown to the voice recognition system has to be recognized, the new word is input into the language identification stage 2, 2′, 2″, 2′″, embodied as a neural network, via the input device 1 in the form of grapheme sequences. This is carried out via the respective grapheme window of the NN language identification stage 2, 2′, 2″, 2′″. The central node of the respective input layer is the grapheme to be considered here. For this grapheme, the assignment, subject to a probability coefficient, to at least one language is determined. The overall score for the entire word is formed by multiplying the individual assignment probabilities, which are obtained when the word is input into the input window, with associated NN calculation for the individual graphemes.

Each language identification stage 2, 2′, 2″, 2′″ then supplies a probability coefficient for the respective language to the language assignment stage 3 in the interval (0 . . . 1). In the example, for the word “window”, a probability coefficient of 0.8 is obtained for English, 0.6 for German and 0.3 for French. These probability coefficients are evaluated in the language assignment stage 3 in terms of their relationship to one another and to the predetermined threshold value.

As a result of this evaluation for the word “window” which has occurred in a hypertext document, a language-specific grapheme-phoneme assignment is generated for the word “window,” for English and German in the corresponding phoneme recognition stages 4, 4′. As the probability coefficient for French was less than a threshold value which is assumed here to be 0.5, the word is not supplied to the phoneme recognition state 4″ for French. The two graphemephoneme assignments which are formed for the word “window” are as follows:

windo (English)

windau (German).

The phoneme sequences which are determined in English and German are then added to the mixed pronunciation lexicon 6 of the HMM speech recognizer 5. In this way, two pronunciation variants for the word “window” are entered into the pronunciation lexicon 6.

This example applies not only to English, German and French but also to other languages as well as to different dialects within a language.

The present invention also basically solves the problem of what is referred to as language mix within a website. If a website contains, for example, the link “Windows 2000”, the German users tend to pronounce the first part “Windows” in the English way and the second part “2000” in German. With a pronunciation lexicon which is based only on one language, hypertext navigation by voice control is not possible under these conditions. A mixed pronunciation lexicon or the use of a number of pronunciation lexicons (for the English and German languages in this case) permits, however, mutually independent, language-related phoneme recognition of the two components of the aforesaid link and, thus, the “mixed-language” voice control of the aforesaid link. If a number of language identification stages are activated, a number of pronunciation variants of a link are also added to the pronunciation lexicon. As a result, mixed links can be easily recognized in this way.

Although the present invention has been described with reference to specific embodiments, those of skill in the art will recognize that changes may be made thereto without departing from the spirit and scope of the present invention as set forth in the hereafter appended claims.

1. A voice recognition method, in particular for navigating in a hypertext navigation system, on the basis of voice inputs in a multiplicity of predetermined languages or dialects in a voice recognizer having a pronunciation lexicon, the pronunciation lexicon being supplemented with new words as grapheme-phoneme assignments by means of a current text document, characterized in that, using a language identification stage which is embodied in particular as a neural network, the assignment to at least one language or one dialect, which assignment is subject to a probability coefficient, is determined for each new word, and the grapheme-phoneme assignment corresponding to the word in the language or dialect with the highest value of the probability coefficient or each language or each dialect for which the probability coefficient exceeds a predetermined threshold value is supplemented in the pronunciation lexicon or at least one of a plurality of pronunciation lexicons.

2. The method as claimed in claim 1, characterized in that the probability coefficients of each word are fed to a language assignment stage, and are evaluated therein in terms of their relationship with one another and/or with the predetermined threshold value, and as a result of the evaluation a language-specific or dialect-specific grapheme-phoneme assignment is generated for the respective word in at least one of a plurality of phoneme recognition stages.

3. The method as claimed in one of the preceding claims, in particular according to claim 1 or 2, characterized in that the assignment to a language or a dialect in the language identification stage is determined by means of the orthography of the word.

4. The method as claimed in one of the preceding claims, in particular in claim 2 or 3, characterized in that pronunciations of the word in the specific language or dialect are generated dynamically in the phoneme recognition stages and supplemented in the pronunciation lexicon or the language-specific or dialect-specific pronunciation lexicon.

5. The method as claimed in one of the preceding claims, in particular according to claim 4, characterized in that the voice recognition device generates HMM state sequences from the dynamically generated pronunciations and enters them into its search space.

6. The method as claimed in one of the preceding claims, characterized in that the language identification stage is formed by a single neural network which has an output node for each predetermined language or dialect, each output node specifying a probability coefficient which indicates that a grapheme window corresponding to the new word belongs to the corresponding language or dialect.

7. The method as claimed in one of the preceding claims, in particular as claimed in one of claims 1 to 5, characterized in that the language identification stage is formed by a multiplicity of neural networks which each have a single output node specifying the probability coefficient which indicates that a grapheme window corresponding to the new word belongs to the corresponding language or dialect.

8. The method as claimed in one of the preceding claims, characterized in that the determination of which language or dialect the new word belongs to and the generation of a language-specific or dialect-specific grapheme-phoneme assignment takes place in a coherent language-specific or dialect-specific neural network which has nodes for voice identification and phoneme assignment in the output layer.

9. The method as claimed in one of the preceding claims, characterized in that, in the language identification stage [lacuna] is obtained from probability coefficients determined on the basis of graphemes, by multiplying the probability coefficients of the word for the respective language or the respective dialect.

10. The method as claimed in one of the preceding claims, in particular as claimed in one of claims 2 to 9, characterized in that an assignment probability for all assignable phonemes is determined in the phoneme recognition stages by means of a neural network calculation process for each grapheme, and the phoneme with the highest assignment probability is selected in such a way that the valid phoneme sequence for the new word is obtained by adding the phonemes with the maximum assignment probabilities for all the graphemes.

11. The method as claimed in one of the preceding claims, characterized in that a training process is carried out as an iterative process, in particular on the basis of the method of “error propagation”, for the neural network, or for each neural network, a pronunciation lexicon with the grapheme sequences contained therein and the associated phoneme sequences being used as training material for each language.

12. The method as claimed in one of the preceding claims, in particular in claim 11, characterized in that
the neural network is trained with the training patterns in a plurality of iterations,
a sequence of training patterns is determined for each iteration by means of a random generator,
after each iteration, the assignment accuracy is checked by means of a validation record which is independent of the training material,
the iterations are continued until the assignment accuracy of the validation record is no longer increased.

13. The method as claimed in one of the preceding claims, characterized in that hypertext documents are used as text documents, new words being formed in particular by means of hyperlinks and/or system instructions.

14. The method as claimed in one of the preceding claims, characterized in that, for a coherent text document, in particular a hypertext document, a statement of assignment, subject to a probability coefficient, to a language or a dialect is determined by evaluating the probability coefficients acquired at the grapheme level or the probability coefficients acquired at the word level, and a language-specific or dialect-specific or multilanguage HMM is activated as a function of the evaluation result.

15. A voice recognition system, in particular for carrying out the method as claimed in one of the preceding claims, for processing voice inputs in a multiplicity of predetermined languages or dialects, which has a dynamically updated pronunciation lexicon, characterized by a language identification stage for determining the assignment of each new word to at least one language or one dialect, which assignment is subject to a probability coefficient.

16. The voice recognition system as claimed in claim 15, characterized by a language assignment stage, connected downstream of the language identification stage, for evaluating the probability coefficients of each word in their relationship with one another and/or with respect to a predetermined threshold value, and a multiplicity of phoneme recognition stages, connected downstream of the language assignment stages, for generating in each case at least one grapheme-phoneme assignment which is valid for the respective word in a language or a dialect.

17. The voice recognition system as claimed in claim 15 or 16, characterized in that the language identification stage and/or the phoneme recognition stages is embodied as a neural network, in particular as a layer-oriented, forward-directed network with full intermeshing between the individual layers.

18. The voice recognition system as claimed in one of claims 15 to 17, in particular claim 17, characterized in that the language identification stage is embodied as an individual neural network with a plurality of output nodes for in each case one language or one dialect.

19. The voice recognition system as claimed in one of claims 15 to 18, in particular claim 18, characterized in that in each case one language identification stage and one phoneme recognition stage for each predetermined language or each dialect are embodied as a coherent neural network which has nodes for voice identification and phoneme assignment in the output layer.

20. The voice recognition system as claimed in one of claims 15 to 19, in particular claim 17, characterized in that the language identification stage for each predetermined language or dialect has a neural network with one output node in each case.

21. The voice recognition system as claimed in one of claims 15 to 20, characterized by means for statistically evaluating the probability coefficients on the grapheme level or word level in order to derive an overall probability coefficient which characterizes the assignment of the entire text document, in particular hypertext document, to a predetermined language or to a dialect.
